(19) United States
(12) Patent Application Publication
(10) Pub. No.: US 2009/0175378 A1
(43) Pub. Date: Jul. 9, 2009

(54) System and Method for Impedance Mismatch Compensation in Digital Communications Systems

(76) Inventors: Robert Bogdan Staszewski, Garland, TX (US); Daquan Huang, Dallas, TX (US); Chih-Ming Hung, McKinney, TX (US)

Correspondence Address: TEXAS INSTRUMENTS INCORPORATED, P O BOX 655474, M/S 3999, DALLAS, TX, 75265, US

(21) Appl. No.: 12/185,920

(22) Filed: Aug. 5, 2008

Related U.S. Application Data
(60) Provisional application No. 61/019,804, filed on Jan. 8, 2008.
(60) Provisional application No. 61/019,806, filed on Jan. 8, 2008.

(51) Int. Cl. H04L 27/00

(52) U.S. Cl. 375/295

(57) ABSTRACT

A system and method for digitally providing impedance mismatch compensation for a communications medium in a communications device. A method comprises producing a power amplifier (PA) output signal, providing the PA output signal to a digitally-controlled transmission line (DCTL), transforming a first load impedance to a second load impedance producing a DCTL output, and coupling the DCTL output to an antenna. The PA having the first load impedance and the transforming is controlled by a digital control word provided to the DCTL.

This application claims the benefit of U.S. Provisional Application No. 61/019,804, filed Jan. 8, 2008, entitled “Tunable Antenna Matching Using Digitally-Controlled Transmission Line,” and U.S. Provisional Application No. 61/019,806, filed Jan. 8, 2008, entitled “Integrated Power Amplifier in Nanometer CMOS with Antenna Mismatch Compensation,” which applications are hereby incorporated herein by reference.

### TECHNICAL FIELD

The present invention relates generally to a system and method for digital communications, and more particularly to a system and method for digitally providing impedance mismatch compensation for a communications medium in a communications device.

### BACKGROUND

Impedance matching may involve attempts to make an output impedance of a source, such as a power amplifier (PA) of a communications device, and an input impedance of a load, such as an antenna or a wired communications medium, attain a desired relationship so that maximum power transfer, maximum voltage transfer, maximum efficiency, minimum signal reflections, and so forth, are achieved.

FIG. 1a illustrates a view of a portion of a wireless communications device 100. The wireless communications device 100 includes a PA 105 (with only an output stage shown) and an antenna 110. The PA 105 may be used to generate a signal at a desired power level to transmit over-the-air using the antenna 110. The PA 105 includes a transistor that may be preferably configured to operate in an efficient region which also produces maximum RF power. Typically, an impedance transformation network may be required to match a low impedance of the low-voltage PA transistor to a higher impedance (typically 50 ohm) of the antenna. The impedance transformation network may be realized as a transmission line 115 having a certain length, l, to connect an output of the PA 105 to an input of the antenna 110. The use of a transmission line of certain length l, with l being a fraction of a signal's wavelength, is well known in the field of microwave design. The PA 105 may have an output impedance (Z_{PA}), the antenna 110 may have an input impedance (Z_{L}) preferably equal to a nominal input impedance Z_{L}(nom) of, e.g., 50 ohm, and the transmission line 115 of length l may have a characteristic impedance (Z₀). The antenna 110 may also see a load impedance when referencing back towards the PA 105. The load impedance of the antenna 110 may be referred to as a reflected load (Z_{R}).

In order to minimize signal reflection at the antenna 110 and to maximize power transfer to the antenna 110, the reflected load (Z_{R}) should be matched to the input impedance (Z_{L}). To help ensure a constant output power by the PA 105, the output impedance (Z_{PA}) of the PA 105 should match the input impedance (Z_{L}) of the antenna 110 as transformed by the transmission line 115.

However, the impedance of antennas may change dynamically. For example, in normal operation, a cellular telephone (a form of the wireless communications device 100) may be brought into close proximity to a user's head when used as a standard handset, the user's body when used with a wired or wireless headset, or placed adjacent to or on top of a large object when used as a speaker phone or when connected to a headset. The close proximity to such large objects may change the impedance of the antenna 110. FIG. 1b illustrates a view of the wireless communications device 100 operating in close proximity to a head/body/object 150. The wireless communications device 100 operating in close proximity to the head/body/object 150 may change the input impedance of the antenna 110, from Z_{L} to Z_{L}(nom), where Z_{L} is not equal to Z_{L}(nom). In general, the degree of change to the input impedance of the antenna 110 may depend on factors such as the size of the head/body/object 150, the composition of the head/body/object 150, the closeness of the head/body/object to the antenna 110, and so forth.

Similarly, the characteristic impedance of a wired communications medium used in a wireline communications device, such as twisted pair or coaxial cable, may also change with time. The change in the input impedance of the antenna 110 may cause the PA 105 and its impedance matching network to not work at an optimum operating point. For example, the reflected load (Z_{R}) may no longer match the input impedance (Z_{L}), and with a different input impedance, the output impedance (Z_{PA}) of the PA 105 may also change. Therefore, the radiated power and power efficiency of the PA 105 may become degraded. The situation may be further exacerbated with fully enclosed antennas and smaller form factor cellular telephones.

Many existing cellular telephones compensate for the changing antenna environment by designing for a worse-case scenario and tolerate high power losses due to reflections. For example, antenna reflections producing a voltage standing wave ratio (VSWR) of 4:1 may experience a power loss of about 2 dB and for a VSWR of 8:1, the power loss may be about 4 dB. Such large power losses may significantly reduce the useful battery life of the cellular telephone, require larger batteries to provide adequate talk times, increase heat dissipation requirements, and so forth.

With the low-cost integration of radio frequency (RF) transceiver circuitry and digital baseband circuitry into a single integrated circuit, a next step in reducing the cost of communications devices may involve the integration of a complementary metal-oxide semiconductor (CMOS) RF PA into a single integrated circuit with the RF transceiver and the digital baseband circuitry. Typically, the high power requirement of a RF PA has precluded the use of CMOS transistors due to their relatively low breakdown voltages. A CMOS RF PA integrated into a single integrated circuit with the RF transceiver and the digital baseband circuitry may increase average efficiency, reduce design complexity and cost of a communications device by reducing parts count, increasing reliability, reducing the size of the communications device, and so forth.

### SUMMARY OF THE INVENTION

These and other problems are generally solved or circumvented, and technical advantages are generally achieved, by embodiments of a system and a method for digitally providing impedance mismatch compensation for a communications medium in a communications device.

In accordance with an embodiment, a method for impedance matching a power amplifier (PA) having a first load impedance to an antenna is provided. The method includes producing a PA output signal, providing the PA output signal to a digitally-controlled transmission line (DCTL), transforming the first load impedance to a second load impedance producing a DCTL output, and coupling the DCTL output to the antenna. The transforming is controlled by a digital control word provided to the DCTL.

In accordance with another embodiment, a power amplifier (PA) is provided. The PA includes a plurality of micro-power amplifier (uPA) circuits, each uPA produces a transmission signal, a plurality of digitally-controlled transmission lines (DCTL), and a power combiner circuit coupled to an output of each DCTL in the plurality of DCTL. With each DCTL coupled to an output of an uPA circuit in the plurality of uPA circuits, the DCTL transforms impedances from an output impedance of a respective uPA circuit to a second impedance, and the power combiner combines outputs of each DCTL into an output of the PA.

In accordance with another embodiment, a communications device comprising an integrated circuit configured to receive signals and to transmit signals using a communications medium is provided. The integrated circuit includes a receiver coupled to the communications medium, a transmitter coupled to a data source and to the communications medium, and a power amplifier (PA) coupled between the transmitter and the communications medium. The receiver receives signals carried on the communications medium, the transmitter processes data provided by the data source for transmission, producing a transmission signal, and the PA generates a plurality of fractional power transmission signals using a plurality of amplifiers, controllably matches an output impedance of each amplifier to a second impedance, and combines an output of each amplifier together to produce the output transmission signal at a desired power level.

In accordance with another embodiment, a method for transmitting a signal at a desired power level is provided. The method includes generating at each power source of a plurality of power sources a respective contributive signal, each respective contributive signal being a fraction of the desired power level, transforming an output impedance of each power source using a digitally-controlled transmission line (DCTL), combining a respective contributive signal from each power source of the plurality of power sources to produce the signal at the desired power level, and coupling the signal to a communications medium.

In accordance with another embodiment, a wireless communications device is provided. The wireless communications device includes an integrated circuit configured to process data for transmission and process received signals from an antenna, and a front-end module coupled to the integrated circuit. The integrated circuit includes an integrated power amplifier with a digitally controlled impedance transformation network, and the front-end module allows a sharing of the antenna by circuitry in the integrated circuit.

An advantage of an embodiment is that it may be realizable in digital CMOS technology, allowing integration into CMOS integrated circuits.

A further advantage of an embodiment is that it allows for impedance matching over a wide range of radio frequency and other high frequency ranges. Furthermore, linear control of impedance transformation is enabled.

Yet another advantage of an embodiment is that the simultaneous matching of antenna impedance and PA output load may be performed. This may help to ensure that signal reflections are reduced or eliminated while maintaining a desired radiated power level, leading to a better average efficiency.

Yet another advantage of an embodiment is that full integration of a communications device is possible, thereby reducing parts count and cost, while increasing reliability.

Yet another advantage of an embodiment is that the use of a transformer in the PA may enable a reuse of space within the transformer for non-PA uses, such as memory, logic, and so forth. This may lead to a better overall usage of available integrated circuit real estate.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of an RF front-end portion of a wireless communications device;

FIG. 1b is a diagram of an RF front-end portion of a wireless communications device operating in close proximity to a head/body/object;

FIG. 1c is a diagram of an isometric view of an artificial dielectric;

FIG. 2a is a diagram of a portion of a wireless communications device having a digitally controllable transmission line (DCTL);

FIG. 2b is a diagram of a top view of an idealized DCTL;

FIG. 2c is a diagram of an isometric view of a DCTL;

FIG. 2d is a diagram of a top view of a DCTL;

FIG. 2e is a diagram of a coupling switch;

FIG. 3a is a diagram of an isometric view of a DCTL;

FIG. 3b is a diagram of a side view of a DCTL;

FIG. 3c is a diagram of a top view of a DCTL using a binary weighting system;

FIG. 4a is a diagram of a Smith chart showing an impedance transformation;

FIG. 4b is a diagram of a portion of a Smith chart showing a range of possible impedance transformations at various frequencies;

FIG. 4c is a diagram of a data plot of signal loss in a DCTL for a range of frequencies and digital control settings;

FIG. 4d is a diagram of a data plot of phase angle versus frequency for a DCTL;

FIG. 4e is a diagram of characteristic impedance versus frequency for a DCTL;

FIG. 5a is a diagram of a sequence of events in the transmission of a signal;

FIG. 5b is a diagram of a sequence of events in the adjusting of an impedance transformation network;

FIG. 5c is a diagram of a sequence of events in the adjusting of an impedance transformation network;

FIG. 6a is a diagram of a high-level view of a portion of a wireless communications device;

FIG. 6b is a diagram of a high-level view of a portion of a wireline communications device;

FIG. 7a is a diagram of a schematic of a power amplifier having an impedance transformation network at an output of a power combiner;

FIG. 7b is a diagram of a schematic of a power amplifier having impedance transformation networks at inputs of a power combiner;

FIG. 7c is a diagram of a schematic of a power amplifier operating using differential mode operation;

FIG. 7d is a diagram of a layout of a power amplifier;

FIG. 7e is a diagram of a layout of a power amplifier using a spiral arrangement for an impedance transformation network;

FIG. 7f is a diagram of a layout of a DCTL;

FIG. 8a is a diagram of an RF front-end portion of a wireless communications device;

FIG. 8b is a diagram of a portion of a wireless communications device with emphasis placed on details of a power amplifier;

FIG. 9a is a diagram of a sequence of events in the transmission of a signal at a desired power level;

FIG. 9b is a diagram of a sequence of events in the generation of a signal at a fraction of a desired power level; and

FIG. 10 is a diagram of a wireless communications device.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless communications device, such as a multi-standard, multi-band, multi-frequency, cellular telephone. The invention may also be applied, however, to other types of wireless communications devices, such as RF transmitters, wireless communications and/or data network infrastructure devices, and so forth. Additionally, the invention may also be applied to a wireline communications device communicating by transmitting signals over a wired communications medium, such as twisted pair, coaxial cable, or so forth.

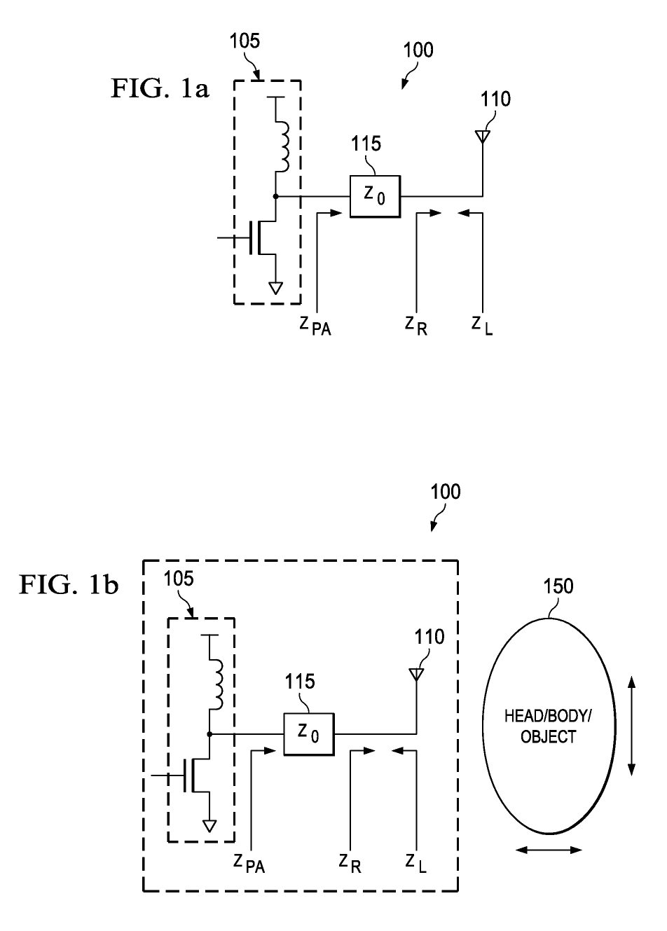

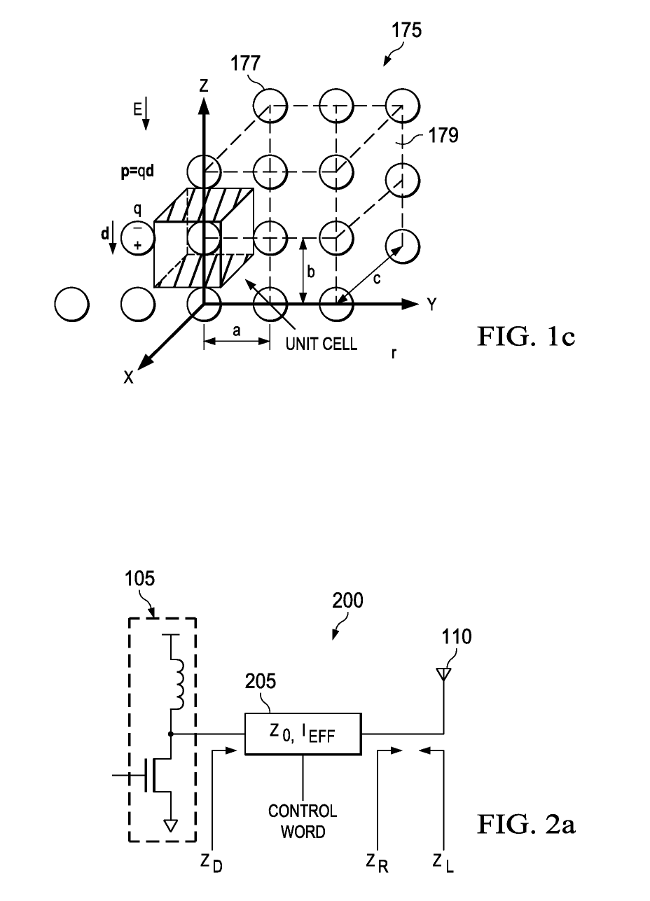

With reference now to FIG. 1c, there is shown a diagram illustrating an isometric view of an artificial dielectric 175. The artificial dielectric 175 may be an array of conducting obstacles, such as obstacle 177, embedded in a dielectric medium 179. The dielectric medium 179 may have a permittivity ∈ᵣ. The conducting obstacles may be substantially identical to one another or they may have different shapes, size, etc. Furthermore, the obstacles may be formed from the same material. However, they may also be formed from different conductive material. The obstacles may be arranged in a regular array, with the array being specifiable using three parameters: a, b, and c.

When an electric field E is applied, displaced charges (q) on the obstacles may induce a dipole field, p=qd, where d is the separation between the obstacles along a given direction. The dipole field may also be expressed as a vector,

$$P = Np = \frac{p}{abc} .$$

A relationship between wavelength of the artificial dielectric 175 and the dielectric medium 179 may be expressed as:

$$κ = {( \frac{{λ}_{medium}}{{λ}_{AC}} )}^{2} ,$$

where κ is relative dielectric constant, λ_{medium} is the wavelength of the dielectric medium 179, and λ_{AD} is the wavelength of the artificial dielectric 175. By altering the permittivity of the artificial dielectric 175, the wavelength of the artificial dielectric 175 may also be reduced. D=∈E+P=κ∈E.

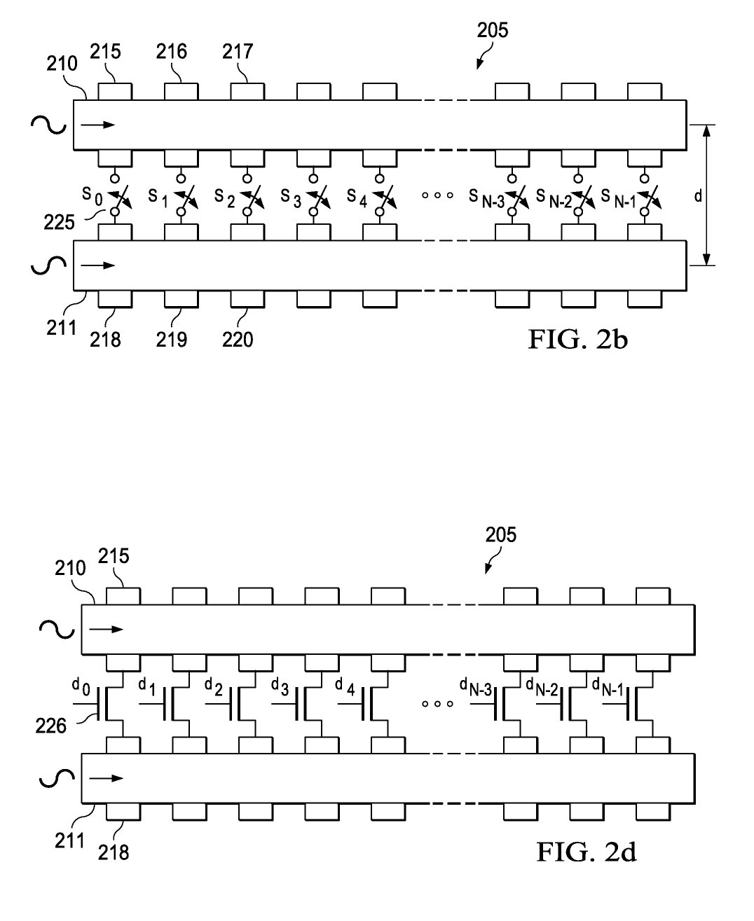

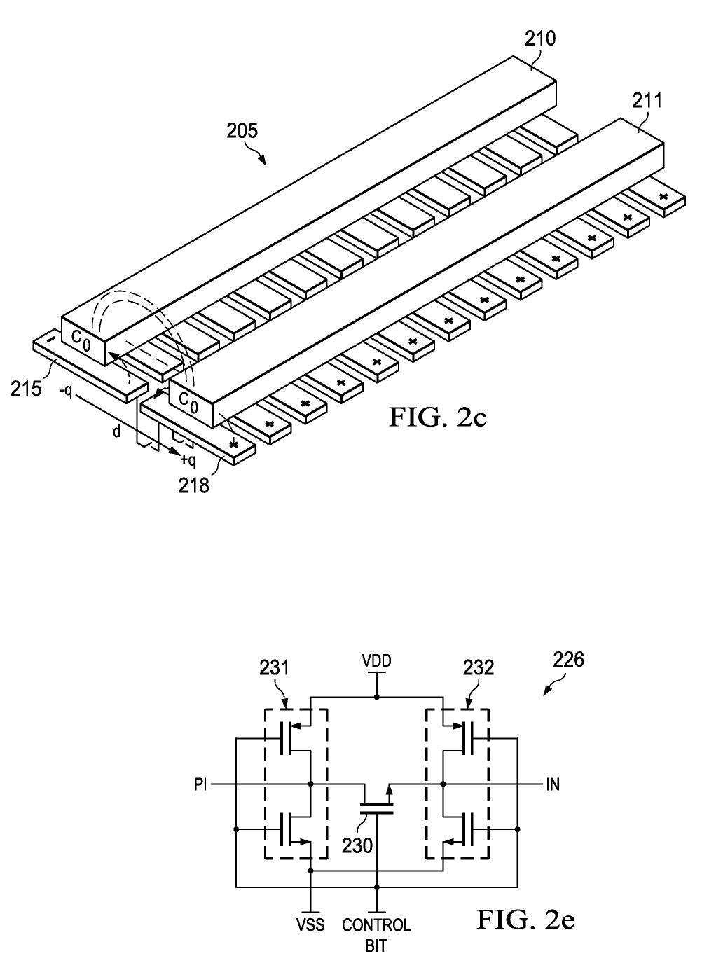

FIG. 2a illustrates a portion of a wireless communications device 200, wherein the wireless communications device 200 includes a digitally controlled transmission line (DCTL) 205 acting as an antenna tuning circuit. The DCTL 205 may be an implementation of an impedance transformation network and may be used to simultaneously match the load impedance (Z_{L}) of the antenna 110 and the reflected load impedance (Z_{R}) seen by the antenna 110 while keeping a drain impedance load (Z_{D}) of the PA 105 constant and preferably at an optimum power setting. This may help to ensure that substantially no signal reflections occur while maintaining a maximum radiated power. The DCTL 205 may have a characteristic impedance (Z₀) and an effective length (l_{EFF}) that may be controlled by control words, such as digital control words, provided by a controller. This way, the antenna and an RF front-end of the transmitter are tuned for the optimal operation.

As the load impedance of the antenna 110 changes due to the wireless communications device 200 being operated in close proximity to a head/body/object, the effective length or an impedance transformation ratio of the DCTL 205 may be changed (increased or decreased) by applying appropriate digital control words so that the load impedance of the antenna 110 and the reflective load impedance seen by the antenna 110 remains substantially matched. Similarly, in a wireline communications device, the antenna 110 may be replaced by a wired communications medium. The antenna tuning circuit may also be realized using lumped LC or RLC components. However, a lumped LC or RLC circuit may not be as advantageous as the transmission line approach since the DCTL 205 may provide the following benefits: (1) higher quality factor Q and larger frequency tuning, (2) larger and more linear phase shift, (3) flat tunable Z₀ over huge bandwidth, (4) lower loss, (5) inherent isolation from underneath material and substrate.

FIG. 2b illustrates a functional top view of a DCTL 205, which uses principles of a digitally-controlled artificial dielectric (DiCAD). The DCTL 205 includes co-planar conductors 210 and 211. The co-planar conductors 210 and 211 may be separated by a distance d. Each of the co-planar conductors 210 and 211 may be formed over a series of floating metal elements, such as metal element 215, 216, and 217, under co-planar conductor 210. Similarly, floating metal elements, such as metal element 218, 219, and 219, may be under co-planar conductor 211. The co-planar conductors 210 and 211 may be separated from themselves and from the series of floating metal elements by a dielectric material (such as silicon dioxide, silicon, air, vacuum, or combinations thereof). A metal element under a first co-planar conductor, such as the metal element 215 under the co-planar conductor 210, may be coupled to a corresponding metal element under a second co-planar conductor, such as the metal element 218 under co-planar conductor 211 with a switch, such as switch S₀ 225. The state of the switch S₀ 225 may be controlled by the digital control words provided by a controller.

The co-planar conductors 210 and 211 may conduct a differential mode signal and may cause a charge of q or −q to form between the co-planar conductors 210 and 211 and the floating metal elements, depending upon the polarity of the signal in a co-planar conductor. Effectively, capacitors of capacitance C₀ may be formed between a co-planar conductor and each of the floating metal elements. In an ideal situation, the charge formed between co-planar conductors 210 and 211 and the floating metal elements induce a dipole field expressible as p=qd, where d is the separation between the co-planar conductors 210 and 211. When a switch, such as the switch S₀ 225 is open, the charge of q and −q may be formed between the co-planar conductors 210 and 211 and the floating metal elements 215 and 218. When the switch S0 225 is closed, then the charge may change largely due to the change in capacitance, resulting in a change in the dipole field. The change in the dipole field may change the permittivity of the DCTL 205 and thereby changing the effective length (l_{EFF}) of the DCTL 205.

FIG. 2c illustrates a functional isometric view of the DCTL 205, illustrating an accumulation of charges q and −q between the co-planar conductors 210 and 211 and the floating metal elements 215 and 218. FIG. 2d illustrates a functional top view of the DCTL 205, wherein the switches, such as switch S₀ 225, are implemented as transistors, such as transistor 226. The transistors may be implemented using a wide variety of different transistor types, including N-type metal oxide semiconductor field effect transistors (MOSFET), P-type MOSFET, bi-polar junction transistors (BJT), and so forth. However, for integration in a CMOS integrated circuit, transistors of type N-type and P-type MOSFET may be preferred.

FIG. 2e illustrates a detailed view of a transistor 226 used to couple the floating metal elements. The transistor 226 may be implemented using a plurality of transistors, including a transistor 230 that may actually be used to couple or decouple the floating metal elements, and weak transistor pairs 231 and 232 that may be used to bias the transistor 230 when the control signal is off.

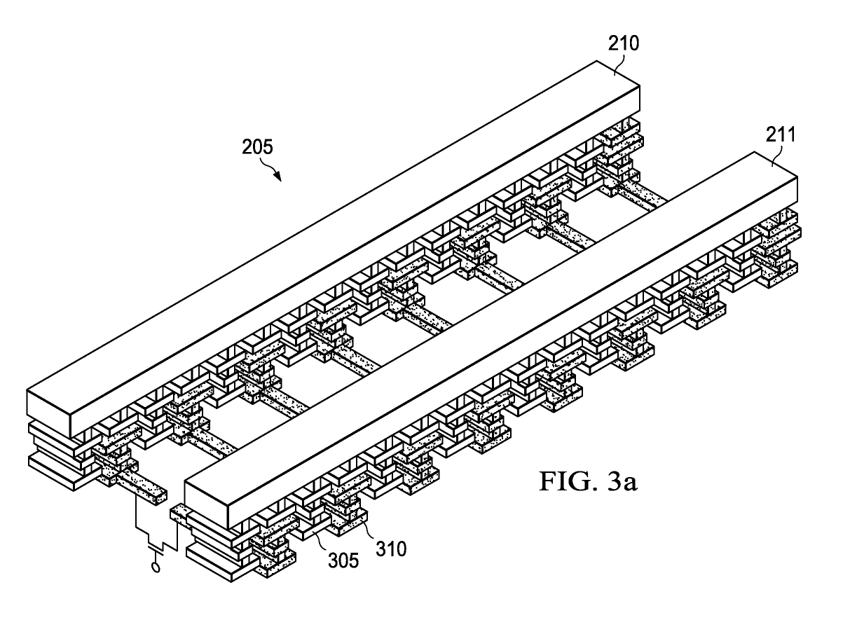

FIG. 3a illustrates an isometric view of the DCTL 205. To increase the amount of change in the effective length of the DCTL 205, it may be necessary to change the amount of charge accumulated between the co-planar conductors 210 and 211 and the floating metal elements. One way to increase the accumulated charge may be to increase the surface area between the co-planar conductors 210 and 211 and the floating metal elements, i.e., increase the size of the capacitors. However, it may be impractical to simply increase the size of the co-planar conductors 210 and 211 and/or the floating metal elements since this may increase the overall size of the DCTL 205 and consume valuable real estate on an integrated circuit containing the DCTL 205.

As shown in FIG. 3a, a multi-layered structure, such as multi-layered structure 305, extending downward from a co-planar conductor, such as the co-planar conductor 211, may function to increase the surface area of the co-planar conductor 211. A similar multi-layered structure, such as multi-layered metal element 310, may be used as a floating metal element. The multiple layers present in the multi-layered structure 305 and the multi-layered metal element 310 may increase the surface area between the co-planar conductors 210 and 211 and the floating metal elements. FIG. 3b illustrates a side-view of the DCTL 205, showing the multi-layered structure 305 and the multi-layered metal element 310.

The diagrams of the DCTL 205 shown in FIG. 2c, FIG. 2d, FIG. 3a, and FIG. 3b have illustrated unity weighted switching. When the DiCAD transmission lines of the DCTL 205 are matched with the characteristic impedance Z₀ on both ends (source and loading), the switching on or off of a single switch (transistor) coupling floating metal elements may have a substantially equivalent impact on the effective length of the DCTL 205. Whether the switch switched on or off is at an end of the DCTL 205, in the middle of the DCTL 205, or at any other position in the DCTL 205, the impact on the effective length of the DCTL 205 may remain substantially remain the same.

It may be possible to implement a different weighting system. For example, a binary weighting system may be implemented, wherein if a first switch (switch #1) may have an impact of one unit of change to the effective length of the DCTL 205, then a switch immediately adjacent to it (switch #2) may have an impact of two units of change to the effective length of the DCTL 205, and a switch two switches away (switch #3) may have an impact of four units of change to the effective length of the DCTL 205, and so forth. In general, a switch #N may impact the effective length of the DCTL 205 by a factor of 2^{(N-1)}.

This may be implemented by changing the flat or multi-layer surface area between the co-planar conductors 210 and 211 and the floating metal elements. Referring back to the example discussed previously, the surface area between the co-planar conductors 210 and 211 and the floating metal elements associated with the switch #1 may be one unit, then the surface area associated with the switch #2 may be two units, the surface area associated with the switch #3 may be four units, and so forth. Other weighting systems may be used. For example, other linear weighting systems such as tertiary (base three), quadiary (base four), quintiary (base five), and so on, as well as non-linear weight systems such as exponential, logarithmic, and so on, may be used. FIG. 3c illustrates a top view of a DCTL 205 utilizing a binary weighting system, wherein switch “d₀” 350 may have only one-eighth the impact on the effective length of the DCTL 205 as switch “d₃” 355.

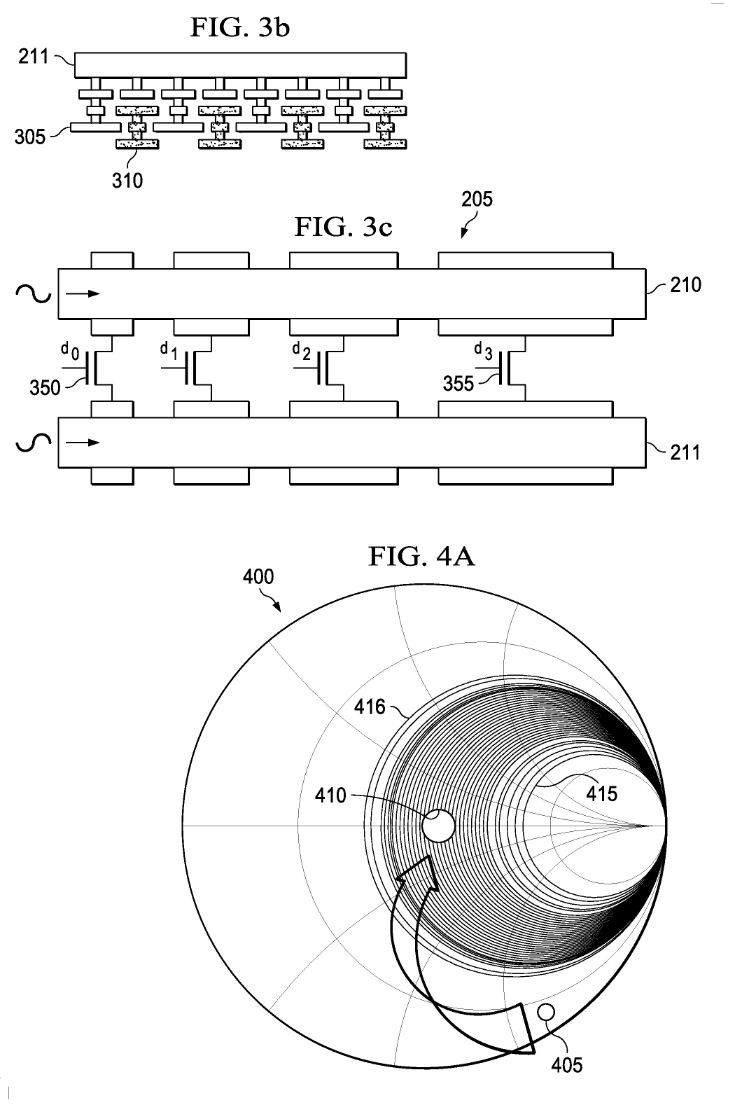

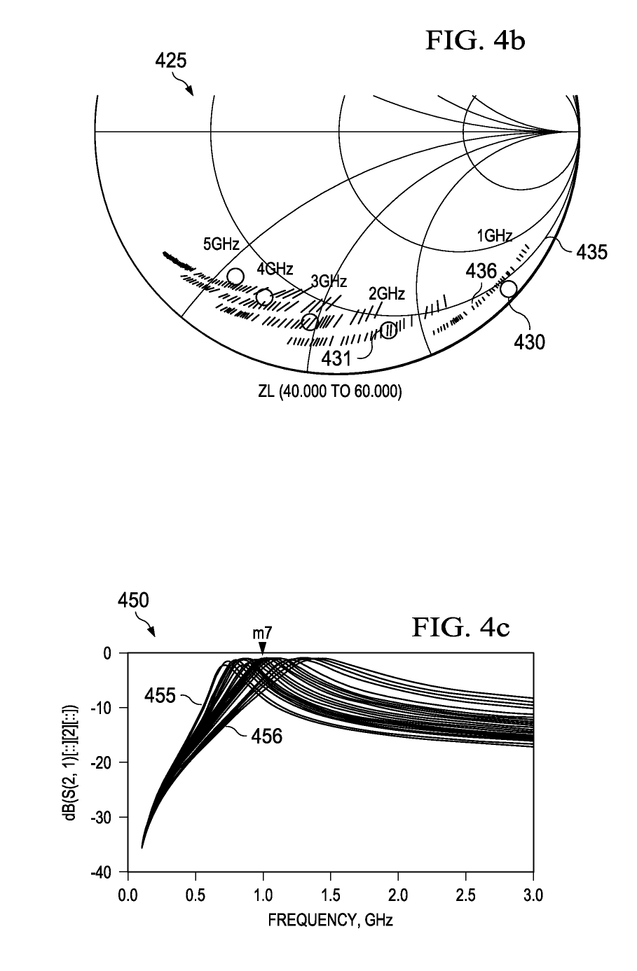

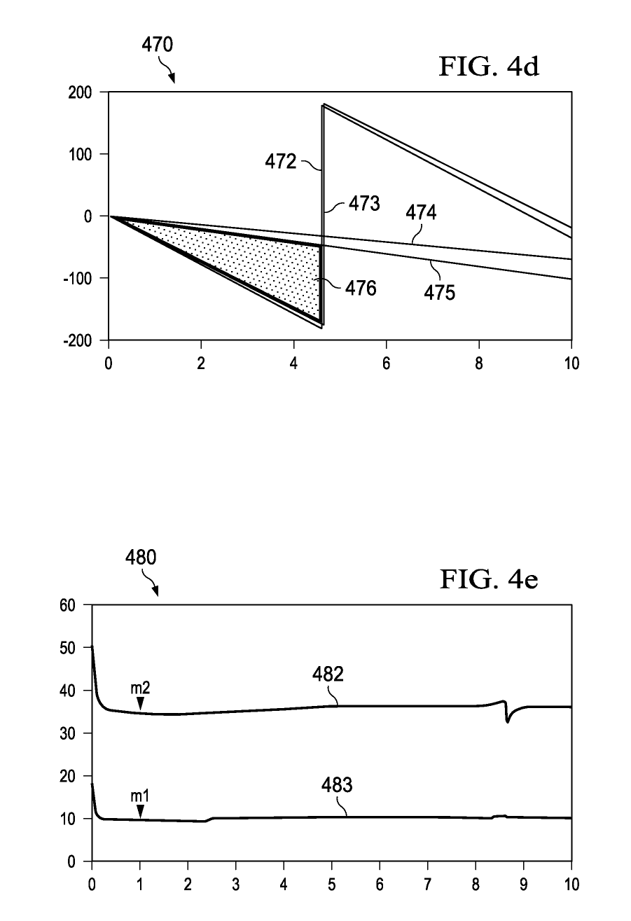

FIG. 4a illustrates a Smith chart 400 showing an impedance transformation performed by a DCTL 205. The impedance transformation may transform a target impedance (Z₀) that may be equal to 10−j*133Ω to a load impedance (Z_{L}) of 50Ω. The target impedance (Z₀) is shown in FIG. 4a as point 405 and the load impedance (Z_{L}) is shown as point 410. Point 410 has been enlarged to enhance visibility in the Smith chart 400. The Smith chart 400 also illustrates a plurality of circles, such as circle 415 and circle 416. The plurality of circles illustrates circles of constant normalized resistance that are producible by different switch settings in the DCTL 205. For example, with the switches of the DCTL 205 in a first set of given states, the impedance transformation performed by the DCTL 205 may be represented by circle 415 and with the switches of the DCTL 205 in a second set of given states, the impedance transformation performed by the DCTL 205 may be represented by circle 416.

FIG. 4b illustrates a portion of a Smith chart 425 showing a range of possible impedance transformations for a DCTL 205. Points, such as point 430 and point 431, represent target impedances for different operating frequencies. For example, point 430 may be the target impedance at 1.0 GHz, point 431 may be the target impedance at 2.0 GHz, and so forth. Region lines, such as region line 435 and region line 436, represent impedance transformations that may be possible by the DCTL 205. FIG. 4b shows that the DCTL 205 may be capable of transforming a wide range of impedances at a wide range of operating frequencies into the target impedances.

FIG. 4c illustrates a data plot 450 of signal loss (S₂₁ parameter transfer function) due to a DCTL 205 as a function of frequency and switch states. Curves, such as curve 455 and curve 456, display signal loss due to the DCTL 205 with the switches of the DCTL 205 in a set of switch states (for example, all switches turned on for a case shown in the curve 455 and all switches turned off for a case shown in the curve 456). The data plot 450 shows a certain level of selectivity. Furthermore, dithering (switching between different sets of switch states) may be used for fine control.

FIG. 4d illustrates a data plot 470 of phase angle versus frequency. A first curve 472 illustrates phase angle versus frequency for a DCTL with an ideal short circuit coupling all floating metal elements, and a second curve 473 illustrates phase angle versus frequency for a DCTL, such as the DCTL 205, with switches made from transistors, such as shown in FIG. 2e, with the switches in an on state. A third curve 474 illustrates phase angle versus frequency for a DCTL with an ideal open circuit coupling floating metal elements, and a fourth curve 475 illustrates phase angle versus frequency for a DCTL, such as the DCTL 205, with the switches made from transistors, such as shown in FIG. 2e, with the switches in an off state. Shaded area 476 illustrates a phase angle tuning range of the DCTL 205. The tuning range may be achieved by change the states of various switches in the DCTL 205. A similar tuning range may also be present for frequencies above 4.6 GHz, but not illustrated in FIG. 4d to maintain simplicity.

FIG. 4e illustrates a data plot 480 of characteristic impedance of a DCTL, such as the DCTL 205, versus frequency. A first curve 482 illustrates the characteristic impedance of the DCTL 205 with all switches in the DCTL 205 in an off state and a second curve 483 illustrates the characteristic impedance of the DCTL 205 with all switches in the DCTL 205 in an on state. The data plot 480 illustrates that the characteristic impedance of the DCTL 205 remains substantially flat over a very wide frequency range.

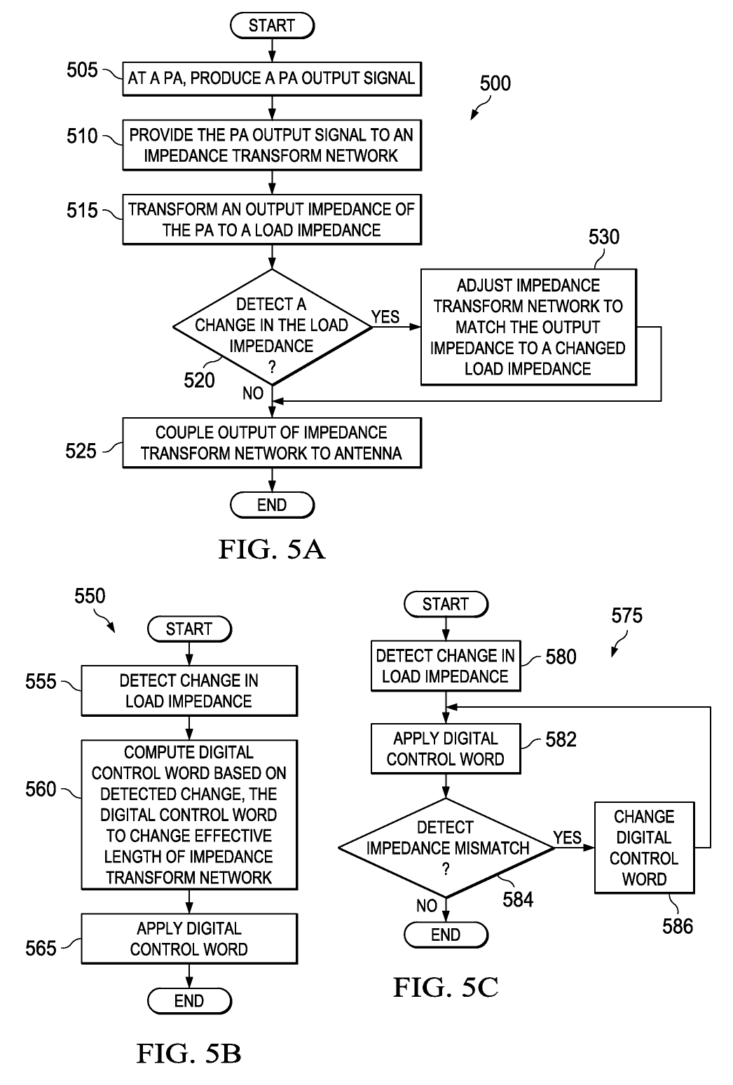

FIG. 5a illustrates a sequence of events 500 in the transmission of a signal. The sequence of events 500 may be descriptive of events occurring in the transmission of a signal in a wireless communications device where the signal is transmitted over the air or a wireline communications device where the signal is transmitted over a wired communications medium. The transmission of the signal may begin with a production of a PA output signal at a PA, such as the PA 105 (block 505). The PA 105 may generate the PA output signal, wherein the PA output signal may be modulated with data to be transmitted and at a desired power level. Alternatively, the PA output signal may be a signal at the desired power level and may be subsequently modulated with the data to be transmitted. Alternatively, the PA 105 may amplify an input signal containing the data to be transmitted to the desired power level.

The PA output signal may then be provided to an impedance transform network, such as the DCTL 205 (block 510). The impedance transform network may be used to transform an output impedance as seen by the PA 105 to a load impedance (block 515). For example, the impedance transform network may transform an output impedance, such as impedance load (Z_{D}) on the PA 105, to a load impedance (Z_{L}) of an antenna, such as the antenna 110. This effectively keeps the impedance load on the PA 105 substantially constant, thus helping to maintain efficient RF power generation. Additionally, the antenna 110 may also see a load impedance (Z_{R}), which is a reflected load. The impedance transform network may also be used to keep the reflected load (Z_{R}) of the antenna 110 and the load impedance (Z_{L}) of the antenna 110 matched.

The impedance transformation of the DCTL 205 may be dynamically changed. The impedance transformation may be controlled by control signals, such as digital control words provided to the DCTL 205. The control signals may be used to set states of switches in the DCTL 205, wherein the switches may be used to couple or decouple floating metal elements in the DCTL 205, such as the floating metal elements 215 and 218. As discussed previously, the coupling or decoupling of floating metal elements in the DCTL 205 may alter dipole field and hence, the effective length (l_{EFF}) of the DCTL 205.

Since it may be possible for impedances to change, for example, the load impedance of the antenna 110 may change if the antenna 110 is brought into close proximity with a head/body/object, it may be necessary to detect a change in the load impedance (block 520). Detecting a change in the load impedance may allow for a change in the impedance transformation performed by the DCTL 205, which may help to ensure that the output impedance of the PA 105 and the load impedance remain matched.

The detection of a possible change in the load impedance may be performed periodically. For example, the detection of a possible change may be performed once every few fractions of a second, seconds, or minutes of operation. A change in the load impedance may be more critical to the performance of a communications device while the communications device is actively receiving or transmitting information, so the period of the detection of a possible change may be shortened while the communications device is actively receiving or transmitting. Alternatively, the detection of a possible change in the load impedance may occur upon an occurrence of an event. For example, the detection of a possible change may be performed prior to an establishing of a call or connection, prior to a transmitting or receiving of a call or connection, prior to each burst/packet transmitted or received, and so forth.

There may be a variety of techniques that are capable of detecting a change in the load impedance. For example, in one technique, the RF output signal may be sensed using a uni-directional coupler looking in a direction of an antenna-reflected propagational signal. A coupled signal (from the uni-directional coupler) may then be rectified using a diode or it may be downconverted using a dedicated receiver or a receiver that is a part of a transceiver that may contain the PA 105. Another technique may measure a time delay of the DCTL 205, which may provide a measure of an impedance mismatch between the antenna 110 and the DCTL 205. The time delay may be measured by providing inputs and outputs of the DCTL 205 to a mixer, whose output may be related to a delay between the inputs and the outputs of the DCTL 205. If multiple DCTLs are used, each may be measured in parallel and the measurements may be treated as an array of feedback signals. The feedback signals may be provided to a control unit that performs joint optimization.

If there is not a detected change in the load impedance (block 520), then the output impedance of the PA 105 and the load impedance may be matched and an output of the impedance transform network, such as the DCTL 205, may then be coupled to an antenna, such as the antenna 110, or a wired communications medium, for transmission (block 525). However, if there is a detected change in the load impedance (block 520), then the output impedance of the PA 105 and the load impedance may be unmatched and the impedance transform network, such as the DCTL 205, may need to be adjusted so that the impedance transformation no longer transforms the output impedance of the PA 105 to a nominal load impedance but from the output impedance of the PA 105 to the changed load impedance (block 530). Alternatively, the impedance change detection technique detects a change in the load impedance and the DCTL 205 may be adjusted to transform the output impedance of the PA 105 to a combination of the load impedance and the change in the load impedance. With the DCTL 205 adjusted, an output of the DCTL 205, may then be coupled to an antenna, such as the antenna 110, or a wired communications medium, for transmission (block 525).

FIG. 5b illustrates a sequence of events 550 in the adjusting of an impedance transform network, such as the DCTL 205, so that an impedance transformation performed by the DCTL 205 is altered based on a detected change in a load impedance. The sequence of events 550 may be an implementation of the adjusting of an impedance transformation network (block 530). The adjusting of the DCTL 205 may begin with a detected change in the load impedance (block 555). The detected change in the load impedance may be in the form of a load impedance or a change (a delta) in impedance. Using the detected change in the load impedance, a digital control word may be computed (block 560). The digital control word may specify a set of switch states of the DCTL 205 so that the effective length (l_{EFF}) of the DCTL 205 is changed to an effective length that will perform a necessary impedance transformation that may match the output impedance of the PA 105 to the detected change in the load impedance. For example, to decrease the effective length of the DCTL 205, additional switches may be turned on. Similarly, to increase the effective length of the DCTL 205, additional switches may be turned off. After the digital control word has been computed, the digital control word may be applied to the DCTL 205 (block 565).

FIG. 5c illustrates a sequence of events 575 in the adjusting of an impedance transform network, such as the DCTL 205, so that an impedance transformation performed by the DCTL 205 is altered based on a detected change in a load impedance. The sequence of events 550 may be an implementation of the adjusting of an impedance transformation network (block 530). Rather than computing a digital control word required to perform the necessary impedance transformation as shown in FIG. 5b, an iterative approach may be used. After detecting a change in load impedance (block 580), a digital control word may be applied (block 582). The applied digital control word may be pre-computed based on expected changes in load impedance and stored in a memory. The application of the digital control word may result in a change in the impedance transformation performed by the DCTL 205.

After the application of the digital control word and potentially allowing an elapsing of a period of time to allow for settling, an attempt to detect an impedance mismatch may be performed (block 584). If there is no detected impedance mismatch or if a detected impedance mismatch is within a tolerable mismatch amount, then the adjusting of the impedance transform network may terminate. However, if there is a detected impedance mismatch or if the detected impedance mismatch is outside of the tolerable mismatch amount, then the digital control word may be changed (block 586) and then applied (block 582). The changing of the digital control word may be an iterative process, with an amount of change being dependent on factors such as the amount of impedance mismatch, how many times the digital control word has been changed, elapsed time since initial impedance mismatch was detected and so forth. The changing of the digital control word may make use of an algorithm such as a least mean square (LMS) algorithm, and so forth.

The changing of the digital control word may continue until there is no longer a detectable impedance mismatch or if there is an impedance mismatch, it is within the tolerable mismatch amount. Alternatively, the changing of the digital control word may continue until the digital control word has been changed too many times without obtaining a desired result, too much time has been devoted to changing the digital control word, or so on.

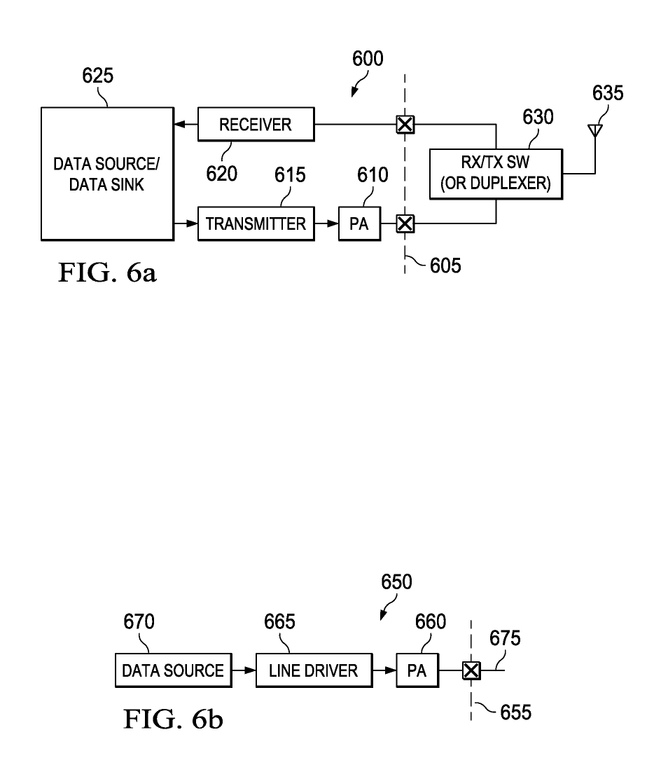

FIG. 6a illustrates a high-level view of a portion of a wireless communications device 600. The wireless communications device 600 includes an integrated circuit 605. The integrated circuit 605 includes a PA 610 integrated with a transmitter 615, a receiver 620, and a data source/data sink 625. The transmitter 615 may be used to process signals provided by the data source/data sink 625 for transmission purposes, such as encoding, interleaving, spreading, modulating, and so forth. The PA 610 may be used to generate a transmission ready version of signals provided by the transmitter 615. The transmission ready version of the signals may be at a desired power level. The PA 610 may also be used to perform and adjust antenna impedance matching to maximize power transfer, maximize voltage transfer, maximize efficiency, minimize signal reflections, and so forth. The receiver 620 may be used to process received signals, such as error detecting and correcting, decoding, de-interleaving, de-spreading, demodulating, and so forth. The processed received signals may be provided to the data source/data sink 625. The antenna impedance matching adjustment for the purpose of enhancing the transmitter's performance may also benefit the receiver's performance since signal reflections between the antenna 635 and receive circuitry may attenuate weak RF signals, degrading the receiver's noise performance.

A receive/transmit switch 630 or a duplexer, or a combination thereof, or so forth, may be used to allow sharing of an antenna 635 by both the transmitter 615 and the receiver 620. The antenna 635 may be external to both the wireless communications device 600 and the integrated circuit 605. Although shown as a single antenna, the antenna 635 may represent multiple antennas, the multiple antennas may be used for transmitting and receiving signals. Alternatively, some of the antennas may be used exclusively for transmitting or receiving signals.

FIG. 6b illustrates a high-level view of a portion of a wireline communications device 650. The wireline communications device 650 includes an integrated circuit 655. The integrated circuit 655 includes a PA 660 integrated with a line driver 665 and a data source 670. The PA 660 may be similar in design to the PA 610 or the PA 660 may use a different design. The line driver 665 may be used to process signals provided by the data source 670 for transmission purposes, such as encoding, interleaving, modulating, spreading, and so forth. The PA 660 may be used to generate a transmission ready version of signals provided by the line driver 665. The transmission ready version of the signals (an output of the PA 660) may then be transmitted to a destination over a wired transmission medium 675. Examples of the wired transmission medium 675 may include twisted pair, coaxial cables, and so forth.

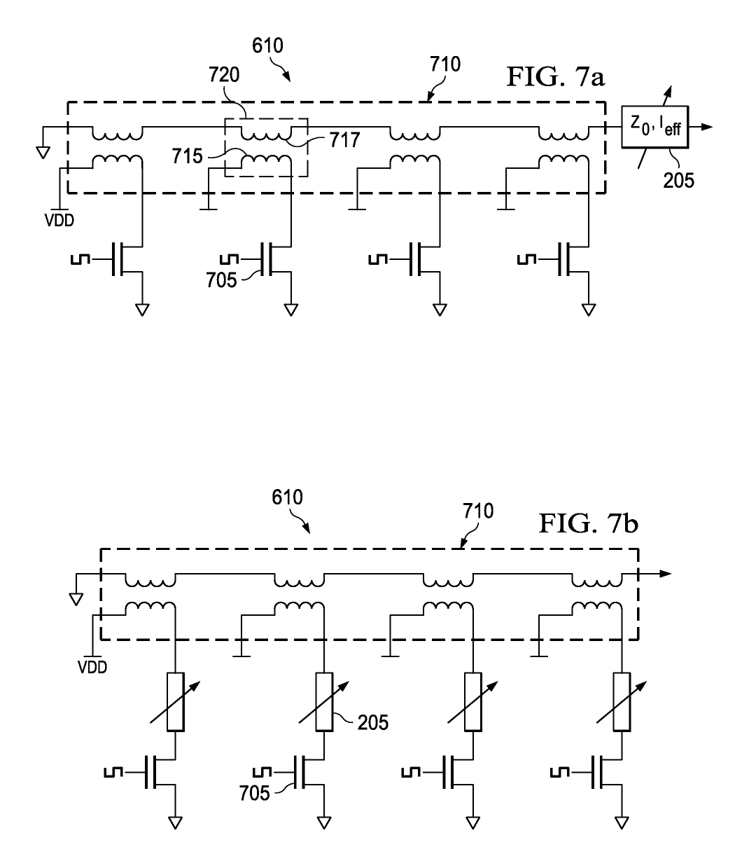

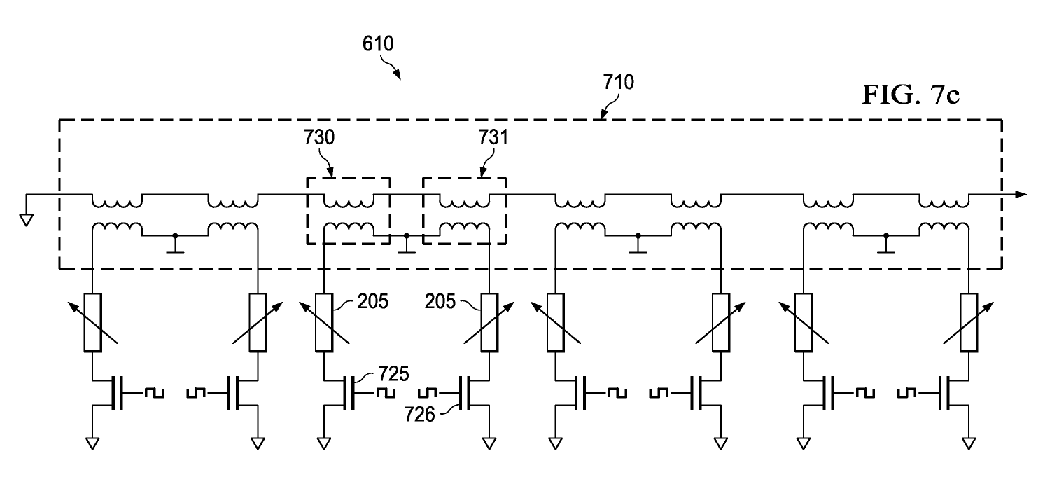

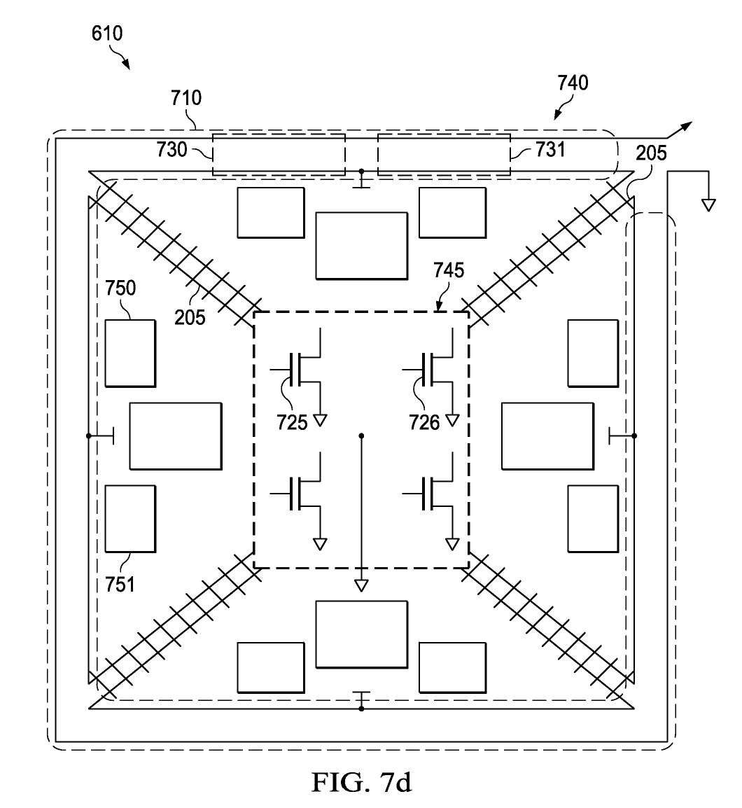

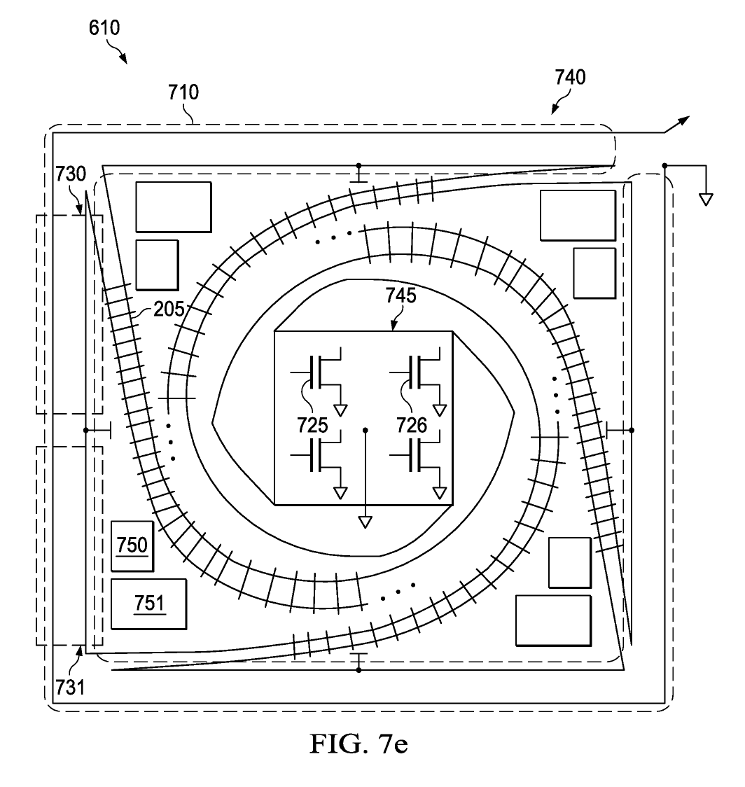

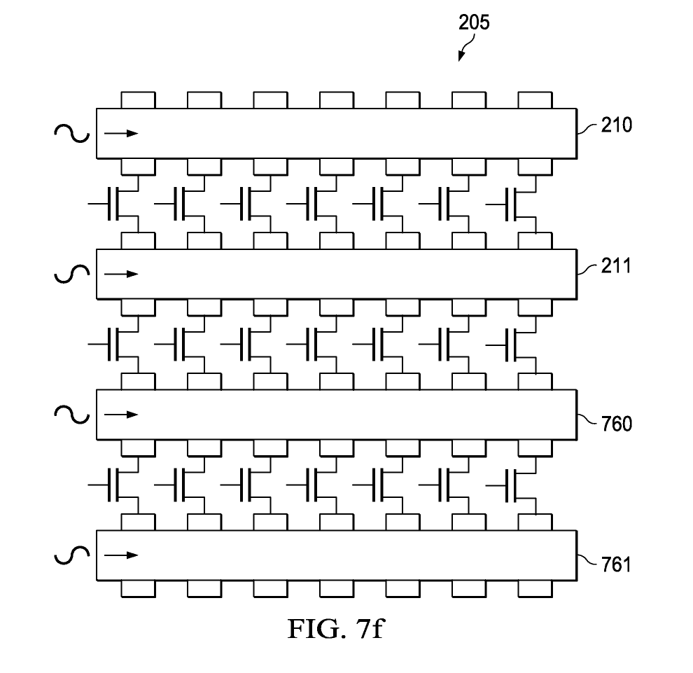

FIG. 7a illustrates a schematic of a PA 610, wherein the PA 610 includes an impedance transformation network, such as the DCTL 205, at its output. A typical PA in a wireless application may be required to provide an output power on the order of 2 watts into a 50 ohm load. This may correspond to a peak voltage of about 36 volts, which may be too high for CMOS transistors to produce. As an alternative, a matching network may be used to transform the 50 ohm impedance to a much smaller value. However, the resulting impedances may be too low and may result in large losses, thereby decreasing the efficiency of the PA.

A power combiner allows for the cumulative combination of power produced by a PA through electromagnetic transformation. The power combiner may enable the use of multiple parallel micro power amplifiers (uPA), with each uPA may be capable of producing a fraction of a total output power desired. The power combiner may then combine the fractional output from each uPA into an output of the PA. The power combiner may be realized as a number of parallel primary windings coupled to a secondary winding.

The PA 610 includes a plurality of uPAs, such as uPA 705, arranged in parallel. Although shown as a single transistor, each uPA may be realized as a plurality of transistors or uPA stages. For example, the uPA 705 may comprise multiple transistors or active devices, with possible numbers including two, three, four, . . . , tens, hundreds, thousands, and so forth. The PA 610 also includes a power combiner 710. Each uPA in the plurality of uPAs, such as uPA 705, may be coupled to the power combiner 710. Each uPA in the plurality of uPAs may be coupled to a primary winding of the power combiner 710, with the primary windings being electromagnetically coupled to a secondary winding. For example, uPA 705 may be coupled to primary winding 715, which may be coupled to a secondary winding 717. The primary winding 715 and the secondary winding 717 may form a transformer 720. The secondary windings of transformers in the power combiner 710 may be arranged in a serial manner, effectively creating a single secondary winding. A first end of the serial arrangement of secondary windings may be coupled to electrical ground and a second end may be an output of the power combiner 710.

Since voltage swings on a primary side of a transformer may be smaller than on a secondary side, it may be advantageous to move components to the primary side of the transformer. FIG. 7a illustrates an embodiment of the PA 610 with an impedance transformation network (the DCTL 205) on a secondary side of transformers, such as transformer 720, in the power combiner 710. However, since the voltage swings on the primary side of transformers may be much smaller, devices may be simpler and smaller, which may allow for better granularity. Furthermore, capacitors having voltage ratings above a certain value may be difficult and/or expensive to realize in CMOS.

FIG. 7b illustrates a schematic of a PA 610, wherein the PA 610 includes impedance transformation networks, such as the DCTL 205, on primary sides of transformers. The PA 610 includes a plurality of uPAs, such as the uPA 705. Coupled to each uPA in the plurality of uPAs and the power combiner 710 may be a DCTL. For example, a DCTL 205 may be coupled between the uPA 705 and the power combiner 710. Each DCTL in the PA 610 may be independently controlled by separate digital control words, or alternatively, a single digital control word may be provided to each DCTL. Furthermore, each DCTL in the PA 610 may be substantially identical with similar impedance transformation ranges, characteristic impedances, and so forth. Alternatively, some or all of the DCTLs in the PA 610 may be different, with different impedance transformation ranges, characteristic impedances, and so on.

The embodiments of the PA 610 shown in FIGS. 7a and 7b illustrate single ended mode operation. Advantages of differential mode operation may include bidirectional current flow through secondary sides of transformers in the power combiner 710, sinusoidal output may be readily provided with little or no filtering, excessive current flow through electrical ground may be avoided, and so forth.

FIG. 7c illustrates a schematic view of a PA 610, wherein the PA 610 makes use of differential mode operation. In order to support differential mode operation, each uPA, such as the uPA 705, shown in FIGS. 7a and 7b may be replaced with a pair of uPAs 725 and 726 arranged pseudo-differentially. As discussed previously, although shown as single transistor, each uPA may comprise multiple transistors. Additionally, DCTLs 205 may be coupled between the uPAs 725 and 726 and a primary winding. Each uPA and DCTL combination in a differential signal pair may be coupled to a transformer in the power combiner 710, such as uPA 725 and DCTL 205 may be coupled to a primary winding of a transformer 730 and uPA 726 and DCTL 205 may be coupled to a primary winding of a transformer 731.

FIG. 7d illustrates a layout of a PA 610, wherein the PA 610 makes use of differential mode operation. Typically, due to the size of the primary and the secondary windings of transformers in the power combiner 710, the power combiner 710 may consume a large percentage of a total area of the layout of the PA 610. Therefore, the power combiner 710 may most significantly impact an overall size of the layout of the PA 610. To minimize overall size, the power combiner 710 may be formed in a perimeter around other components in the PA 610.

As shown in FIG. 7d, the power combiner 710 may be formed having a four-sided polygonal shape, with each side including two transformers. For example, a top side 740 of the power combiner 710 includes the transformer 730 and the transformer 731. Although shown in FIG. 7d as being formed in a four-sided configuration, the power combiner 710 may be formed in a variety of shapes, with the shape potentially being determined by factors such as: a number of transformers in the power combiner 710, ease of fabrication, available area, desired performance, and so forth. Other possible shapes may include polygons having three, five, six, and so forth, sides.

The layout of the PA 610 also includes an uPA core 745. The uPA core 745 may contain the plurality of uPAs, such as uPAs 725 and 726, used to generate the output power of the PA 610, with each uPA generating a fraction of the output power. The uPA core 745 may be located at about a center of the power combiner 710. A location at about the center of the power combiner 710 may enable the formation of the multiple DCTL 205 with substantially equal lengths. However, if there is a desire to form the multiple DCTL 205 with different lengths, the placement of the uPA core 745 may be adjusted to facilitate such a design. In order to maximize the lengths of the multiple DCTL 205 as well as minimizing the size of the layout of the PA 610, the various DCTL 205 may be formed so that they couple to the power combiner 710 at corners of the power combiner 710.

Unlike an inductor, wherein an electric field generated by the inductor may penetrate the interior of the inductor, an electric field generated in a transformer may be substantially contained between the primary and the secondary windings of the transformer, with relatively small stray inductance. Therefore, it may be possible to place components that are or are not part of the PA 610 inside the layout of the PA 610. Blocks 750 and 751 may be placed interior to the power combiner 710. This may further increase area usage and increase efficiency. Examples of components that may be placed inside the power combiner 710 may include memories (including RAM, ROM, and so forth), logic, controllers, processors, digital signal processors, and so forth.

FIG. 7e illustrates a layout of a PA 610, wherein the multiple DCTL 205 are formed in spiral pattern. Rather than forming the multiple DCTL 205 as straight lines, the multiple DCTL 205 may be formed in a spiral pattern. The use of a spiral pattern may enable the creation of longer transmission lines while remaining within physical constraints of the power combiner 710. The longer transmission lines may enable a wider impedance transformation range.

FIG. 7f illustrates a layout of a DCTL 205 that may be applicable, for example, when the DCTL 205 is created using a spiral pattern. In this case, transmission line elements from various sources may come in close proximity and interact with each other. In this case, it may be beneficial to extend the coupling between two conductors as discussed in previously discussed examples of the DCTL to coupling between multiple (more than two) conductors. The diagram shown in FIG. 7f shows that co-planar conductors 210, 211, 760, and 761, are formed in close proximity to allow stronger coupling and thus wider control of the impedance transformation.

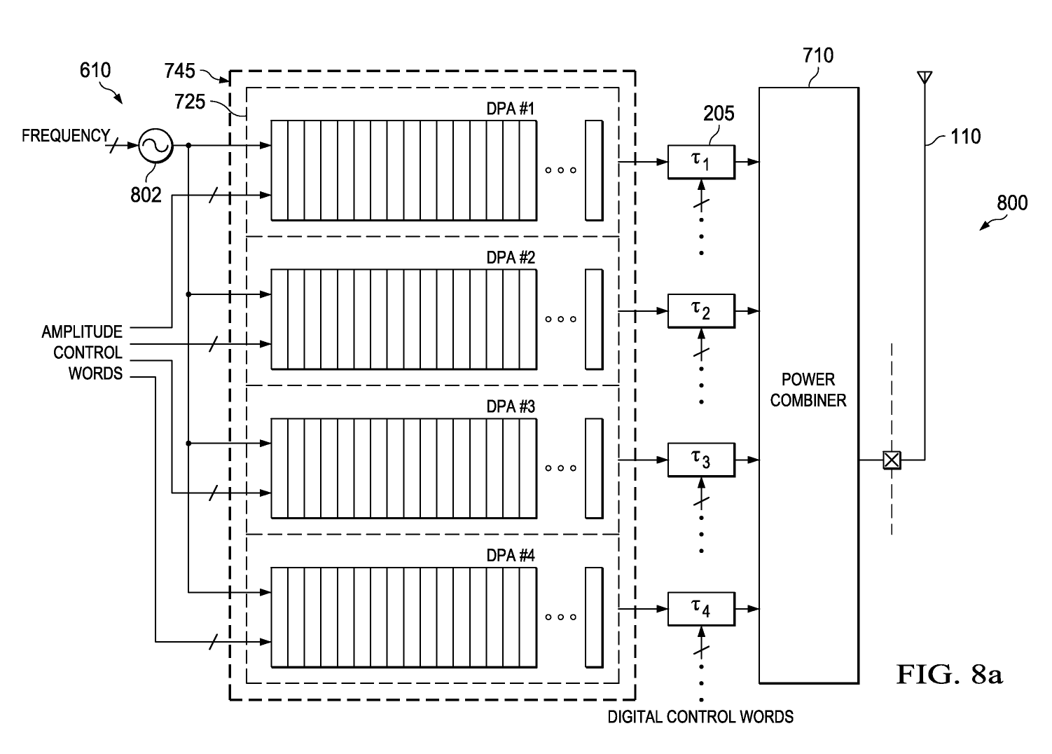

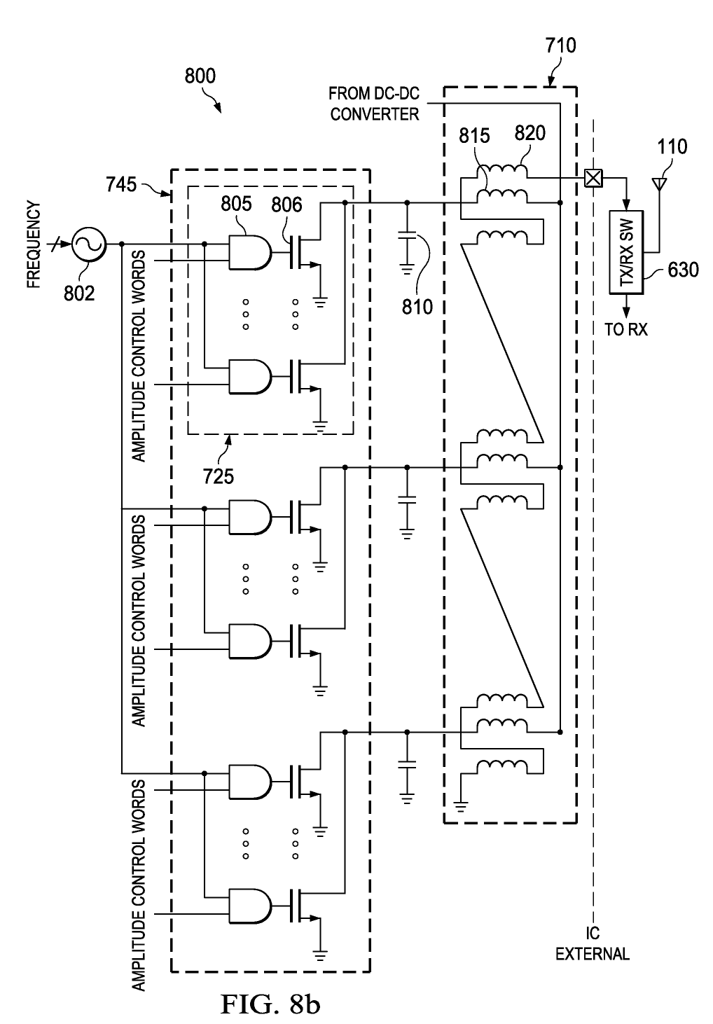

FIG. 8a illustrates a block diagram of a portion of a wireless communications device 800, with emphasis placed on details of a PA 610. The uPA core 745 of the PA 610 includes a plurality of uPAs, such as uPA 725. Each uPA in the plurality of uPAs may be implemented as one or more digital power amplifier (DPA). Each uPA may produce an output corresponding to a fraction of the output power of the PA 610, with the fraction of the output power produced by each uPA being specified by amplitude control bits provided to an input of each uPA. Also input to each uPA may be a clock signal (provided by oscillator 802), the clock signal may be gated to enable or disable a particular uPA.

Each uPA may then provide an output that contains the signal being transmitted at a fraction of the output power of the PA 610. Each uPA may provide a substantially equal fraction of the output power of the PA 610 and may be provided the same digital control bits. Alternatively, each uPA may be able to provide a different fraction of the output power of the PA 610 and may be provided with unique digital control bits.

An output produced by an uPA comprising the signal being transmitted at a fraction of the output power of the PA 610 may then be impedance matched by a DCTL, such as the DCTL 205. The impedance matching performed by each DCTL may be controlled by a digital control word provided to the DCTL. Each DCTL may provide a substantially equal amount of impedance transformation and may be provided the same digital control word. Alternatively, each DCTL may be capable of providing a different amount of impedance transformation and may be provided with a different digital control word.

In addition to impedance matching performed by the DCTL 205, the DCTL 205 may perform a timing alignment on the output signal produced by each of the uPAs. Timing alignment may help to maximize the combination of the output signals produced by each of the uPAs. Alternatively, dedicated timing alignment circuitry may be used to perform the timing alignment. The timing alignment performed in the PA 610 may be dependent on factors such as transmitter topology (for example, Cartesian or polar), wireless standard, and so forth. The amount of timing alignment may range from tens of nano-seconds for GSM/EDGE (a 2G wireless standard) to single digit or fractions of nano-seconds for WCDMA (a 3G wireless standard). Timing misalignment may create modulation distortion and/or additional frequency components, which may reduce a communication device's operational margin or even violate the wireless standard's specifications. Timing alignment may be adjusted manually based on characterization of the PA 610 or an integrated circuit containing the PA 610, factory calibration of each component of the transmitter separately, upon communications device power-up, during regular operation, or so on. A metric that may be used for timing alignment calibration may be maximum output power, maximum efficiency, or so forth.

Outputs from the DCTLs may then be provided to a power combiner, such as the power combiner 710, where the impedance matched (and time aligned) outputs of the uPAs may then be combined to produce an output signal.

FIG. 8b illustrates a detailed view of a portion of a wireless communications device 800, with emphasis placed on details of a PA 610. FIG. 8b provides a detailed view of an implementation of an uPA, such as the uPA 725, of the uPA core 745. The uPA 725 includes a plurality of logic gates, such as a logical AND gate 805. The logical AND gate 805 may have as inputs the amplitude control bits correspond and a clock signal as provided by the oscillator 802. The logical AND gate 805 may control a transistor 806 (shown as an NMOS transistor), turning the transistor 806 on or off depending on its inputs. The uPA 725 may include a plurality of transistors, such as the transistor 806. Depending on the amplitude control bits, one or more logic gates in the plurality of logic gates may turn on their corresponding transistors to produce a controlled fraction of the output power of the PA 610. Other uPAs in the uPA core 745 may each comprise a plurality of transistors, with a number of transistors in each plurality of transistors being the same or different for the various uPAs.

For example, when the output of the oscillator 802 is high, for example, and the amplitude control bits specify that the logical AND gate 805 should be turned on, then an output of the logical AND gate 805 is high. The output of the logical AND gate 805 may be coupled to a gate terminal of the transistor 806 and when the output of the logical AND gate 805 is high, the transistor 806 is turned on, permitting a current to momentarily (i.e., for a fraction of the RF cycle) flow through the transistor 806. However, when either the output of the oscillator 802 and/or the digital control bits specifying the logical AND gate 805 is low, then the output of the logical AND gate 805 is low and the transistor 806 is turned off and not allowing a current to flow through the transistor 806. The other logical AND gate and transistor pairs may be similarly configured. The regulation of the number of active switches may allow for the amplitude control of an RF envelope or lower-frequency power control. Alternatively, if two such structures are used, it could be used as part of I/Q (Cartesian) transmit modulation.

Although the discussion focuses on logical AND gates and NMOS transistors, other types of logic gates, such as logical OR, logical exclusive-OR, logical NAND, logical NOR, and so forth, and transistors, such as PMOS, BJT, DMOS, and so on, may be used. Therefore, the discussion of AND gates and NMOS transistors should not be construed as being limiting to either the scope or the spirit of the embodiments.

Capacitors coupled to an output of each uPA, such as capacitor 810 coupled to an output of the uPA 725 may be required for the switched mode of operation. Their purpose may be similar to that in class-E PA's, which is to keep drain voltage low while the transistor's gate starts dropping. The outputs of each uPA may then be coupled to a primary winding, such as primary winding 815, of the power combiner 710, with a signal on the outputs of each uPA being coupled to a secondary winding, such as secondary winding 820. The output of the PA 610 may be a cumulative power addition of the signals coupled onto the secondary windings of the power combiner 710.

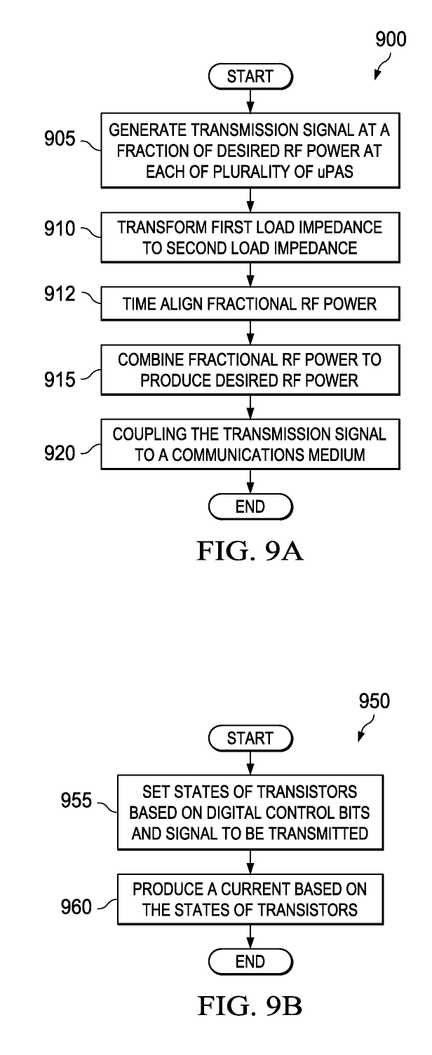

FIG. 9a illustrates a sequence of events 900 in the transmission of a transmission signal at a desired power level. The sequence of events 900 may be descriptive of events occurring in the transmission of a transmission signal at a desired power level for use in a wireless communications device or a wired communications device. The transmission of a transmission signal at a desired power level may begin with a generation of the transmission signal at a fraction of the desired power level at each of a plurality of uPAs (block 905). Preferably, the fraction of the desired power level generated at each uPA of the plurality of uPAs may be based on a number of uPAs in the plurality of uPAs. For example, if there are four uPAs, then each uPA may generate the transmission signal with each transmission signal being at about one-fourth of the desired power level. Similarly, if there are eight uPAs, then each would generate the transmission signal at about one-eighth of the desired power level. As described above, the transmission signal produced by one uPA may be substantially equal to the transmission signal produced by other uPAs. Alternatively, the transmission signal produced by one uPA may differ from the transmission signal produced by other uPAs in terms of power level.

After each uPA generates its fraction of the transmission signal, the transmission signal may be provided to an impedance transformation network at an output of each uPA, wherein the impedance transformation network may transform an output impedance of an uPA to a load impedance (block 910). The impedance transformation performed by the impedance transformation networks may be dynamically changed to provide compensation for a change in the load impedance. For example, the impedance transformation network may be a DCTL, such as the DCTL 205, wherein digital control words may affect an effective length (l_{EFF}) of the DCTL 205 by coupling or de-coupling floating metal elements, such as metal elements 215 and 218, positioned underneath co-planar conductors, such as co-planar conductors 210 and 211. Changing the effective length (l_{EFF}) of the DCTL 205 may change the impedance transformation performed by the DCTL 205.

In addition to the impedance transformation performed by the DCTL 205, the transmission signal, as generated by each uPA, may also be time aligned (block 912). The time alignment may help to maximize a resulting power level of the individual transmission signals. The time alignment may be performed by the DCTL 205 through its ability to alter the effective length of the impedance transformation network or by a time alignment circuit coupled to each of the uPAs.

After the transmission signal, as generated by each uPA, passes through the DCTL 205 and have been time aligned, they may be combined to produce the transmission signal at the desired power level (block 915). The transmission signal at a fraction of the desired power level, as generated by the uPAs and after passing through the impedance transformation network, may be combined into the transmission signal at the desired power level by a power combiner, such as the power combiner 710. The output of each uPA may be provided to a primary winding of one transformer of a plurality of transformers in the power combiner 710, where it may be coupled onto a secondary winding of the transformer. The secondary windings of the plurality of transformers may be arranged in a serial manner, with a first end of the serial arrangement being coupled to electrical ground and a second end being an output of the power combiner 710. The output of the power combiner 710 may provide the transmission signal at the desired power level, ready for transmission. The transmission signal at the desired power level may then be coupled to a communications medium, such as a wireless communications medium or a wired communications medium (block 920).

Although in the sequence of events 900, the outputs of each uPA may be transformed by the impedance transformation network prior to being combined to produce the transmission signal at the desired power level, it may be possible to combine the outputs of each uPA and then perform the transforming by a single impedance transformation network located at an output of the power combiner. Alternatively, the outputs of each uPA and the output of the power combiner may all undergo impedance transformation, with impedance transformation networks at outputs of each uPA and a single impedance transformation network at the output of the power combiner.

FIG. 9b illustrates a sequence of events 950 in the generation of a transmission signal with a fraction of the desired power level. The sequence of events 950 may be descriptive of events occurring in an uPA, such as uPA 725, of a PA, such as the PA 610. The generation of the transmission signal may begin with a setting of states of transistors (PAs) in the uPA 725 (block 955). The states of the transistors in the uPA 725 may be dependent on logical values of amplitude control bits provided to the uPA 725.

The transmission signal may then be produced based on the states of the transistors (block 960). For example, if a transistor is turned on by the logical combination of the digital control bits and the clock signal, then a current flowing through the transistor may contribute to the transmission signal produced by the uPA 725.

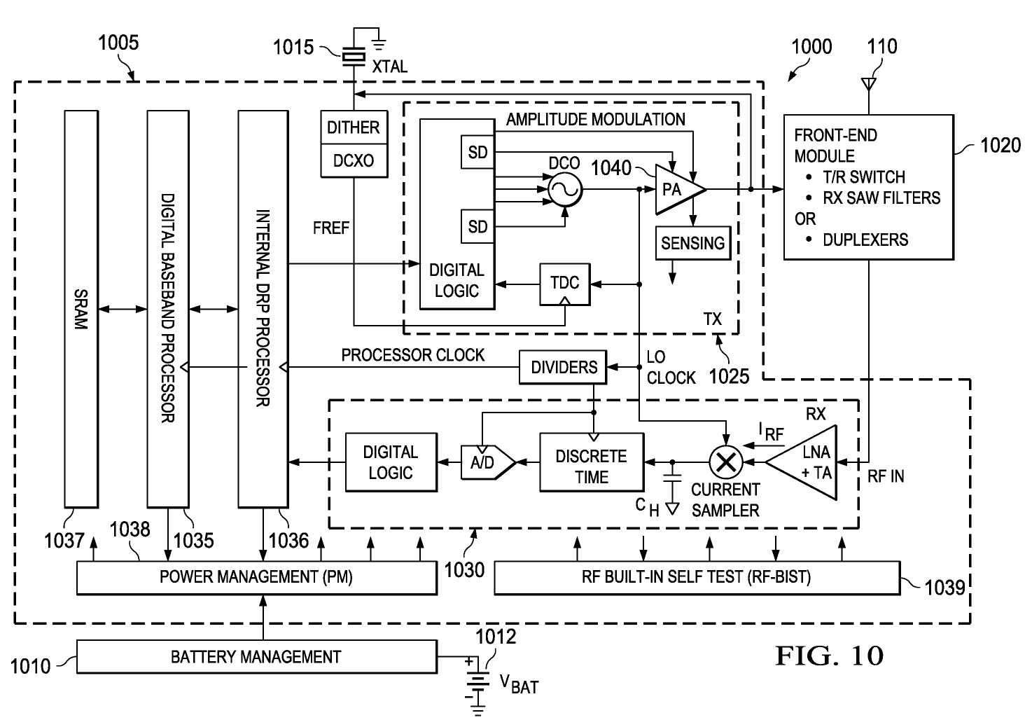

FIG. 10 illustrates a view of a wireless communications device 1000, such as a cellular phone. Specifically, the wireless communications device 1000 may be a multi-band, multi-frequency, multi-standard cellular telephone. The wireless communications device 1000 may contain an integrated circuit or a system on a chip (SoC) 1005 containing a majority of the functionally of the wireless communications device 1000. The integrated circuit 1005 may integrate RF, analog, mixed-signal, digital, and memory functions on a single integrated circuit. In addition to the integrated circuit 1005, the wireless communications device 1000 may include battery management circuitry 1010, which may further include battery charging circuitry, and a battery 1012 for providing electrical power to the wireless communications device 1000, a crystal 1015 for providing a reference frequency signal, a front-end module 1020, and an antenna 110. The front-end module 1020 may include transmit/receive switches, receiver SAW filters, and/or duplexers.

The remainder of the functionality of the wireless communications device 1000 may be contained in the integrated circuit 1005. The integrated circuit 1005 may include a transmitter 1025 that may be used to process data for transmission, a receiver 1030 that may be used to receive signals, a digital baseband (DBB) processor 1035, a digital RF processor (DRP) or a dedicated controller or processor 1036, memory 1037, power management circuitry 1038, self-test circuitry 1039, and so forth. The DBB processor 1035 may be used to process signals to be transmitted and/or received by the wireless communications device 1000, while the general purpose processor 1036 may be used to execute applications executing on the wireless communications device 1000 as well as providing user interface functionality, and so forth. The power management circuitry 1038 may be used to help manage the power consumption of the wireless communications device 1000 and the self-test circuit 1039 may enable the wireless communications device 1000 ensure that it is operating properly.

The transmitter 1025 may include an integrated power amplifier (PA) 1040. The integrated PA 1040 may generate signals for transmission at a desired power level. The integrated PA 1040 may be implemented using a DCTL 205, such as shown in FIGS. 7d and 7e, to provide digitally controlled impedance matching. Since the PA 1040 is integrated on the same silicon die with the rest of the RF transceiver, along with the DRP processor 1036 and DBB processor 1035, the antenna mismatch sensing may be conveniently implemented on-chip and calibration/compensation computations performed using one of the internal processors, such as the DRP processor 1036, the DBB processor 1035, or so forth. This may especially be convenient for the factory calibration and configuration, at which time, the DBB processor 1035 is not needed for a mission-mode operation.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for impedance matching a power amplifier (PA) having a first load impedance to an antenna, the method comprising:
producing a PA output signal;
providing the PA output signal to a digitally-controlled transmission line (DCTL);
transforming the first load impedance to a second load impedance producing a DCTL output, wherein the transforming is controlled by a digital control word provided to the DCTL; and
coupling the DCTL output to the antenna.

2. The method of claim 1, wherein the first load impedance is an output impedance of the PA and the second load impedance is a characteristic impedance of the antenna.

3. The method of claim 1, further comprising, detecting an impedance mismatch between the DCTL and the antenna.

4. The method of claim 3, wherein the transforming comprises transforming the first load impedance to a combination of the second load impedance and the impedance mismatch.

5. The method of claim 3, wherein the detecting is performed dynamically.

6. The method of claim 3, wherein the detecting comprises coupling a signal reflected from the antenna to a receiver or measuring a time delay of the DCTL.

7. The method of claim 3, wherein the transforming comprises:
computing the digital control word based on the detected impedance mismatch; and
applying the digital control word.

8. The method of claim 3, wherein the transforming comprises applying a series of iteratively changed digital control words to reduce the detected impedance mismatch.

9. The method of claim 1, wherein the transforming comprises adjusting an effective length of the DCTL based on the digital control word.

10. The method of claim 9, wherein the transforming comprises switching on or off switches in the DCTL based on the digital control word.

11. The method of claim 1, wherein the transforming is dynamically adjusted to maintain a substantially constant load impedance for the PA.

12. The method of claim 1, wherein the transforming is dynamically adjusted to minimize antenna reflections.

13. A power amplifier (PA) comprising:
a plurality of micro-power amplifier (uPA) circuits, each uPA configured to produce a transmission signal;
a plurality of digitally-controlled transmission lines (DCTL), each DCTL coupled to an output of an uPA circuit in the plurality of uPA circuits, the DCTL configured to transform impedances from an output impedance of a respective uPA circuit to a second impedance; and
a power combiner circuit coupled to an output of each DCTL in the plurality of DCTL, the power combiner configured to combine outputs of each DCTL into an output of the PA.

14. The PA of claim 13, wherein each DCTL in the plurality of DCTL is further configured to time align the output impedance of the respective uPA circuit.

15. The PA of claim 13, wherein each uPA comprises a MOS transistor.

16. The PA of claim 13, wherein each uPA comprises a plurality of MOS transistors.

17. The PA of claim 13, wherein each DCTL is a digitally-controlled artificial dielectric.

18. The PA of claim 17, wherein each DCTL comprises:
a pair of co-planar conductors, wherein a first co-planar conductor to conduct a first signal and a second co-planar conductor to conduct a second signal;
a plurality of floating metal elements disposed underneath the pair of co-planar conductors, the plurality of floating metal elements arranged in two sequences of metal elements, with a first sequence of metal elements disposed beneath the first co-planar conductor and a second sequence of metal elements disposed beneath the second co-planar conductor; and
a plurality of switches, each switch having a first terminal coupled to a floating metal element in the first sequence of metal elements and a second terminal coupled to a floating metal element in the second sequence of metal elements, the switch to couple or decouple the floating metal elements responsive to a control signal provided to the switch.

19. The PA of claim 18, wherein the plurality of switches comprises MOS transistors.

20. The PA of claim 13, wherein the second impedance changes dynamically, and wherein a respective DCTL dynamically transforms an output impedance of a respective uPA to a changed second impedance.

21. The PA of claim 20, wherein the respective DCTL transforms the output impedance of the respective uPA to substantially match the changed second impedance.

22. The PA of claim 13, wherein output of the PA is coupled to an antenna or a wired communications medium.

23. The PA of claim 13, further comprising an output DCTL coupled to an output of the power combiner circuit, the output DCTL configured to transform impedances from an output impedance of the power combiner circuit to a third impedance.

24. The PA of claim 13, wherein the power combiner circuit comprises:
a plurality of primary windings arranged in parallel, each primary winding coupled to an output of a DCTL in the plurality of DCTL; and
a plurality of secondary windings arranged sequentially, each secondary winding electromagnetically coupled to a primary winding in the plurality of primary windings.

25. The PA of claim 24, wherein the plurality of secondary windings having a first ending coupled to an electrical ground and a second ending coupled to the output of the PA.

26. The PA of claim 13, further comprising a plurality of time alignment circuits, each time alignment circuit coupled between a DCTL of the plurality of DCTL and the power combiner, the time alignment circuit configured to time align the outputs of the plurality of DCTL.

27. A communications device comprising an integrated circuit configured to receive signals and to transmit signals using a communications medium, the integrated circuit comprising:
a receiver coupled to the communications medium, the receiver configured to receive signals carried on the communications medium;
a transmitter coupled to a data source and to the communications medium, the transmitter configured to process data provided by the data source for transmission, producing a transmission signal; and
a power amplifier (PA) coupled between the transmitter and the communications medium, the PA configured to generate a plurality of fractional power transmission signals using a plurality of amplifiers, to controllably match an output impedance of each amplifier to a second impedance, and to combine an output of each amplifier together to produce the output transmission signal at a desired power level.

28. The communications device of claim 27, wherein the PA comprises:
a plurality of micro-power amplifier (uPA) circuits;
a plurality of digitally-controlled transmission lines (DCTL), each DCTL coupled to an output of an uPA circuit in the plurality of uPA circuits, the DCTL configured to transform impedances from an output impedance of a respective uPA circuit to the second impedance; and
a power combiner circuit coupled to an output of each DCTL in the plurality of DCTL, the power combiner configured to combine outputs of each DCTL into an output of the PA.

29. The communications device of claim 27, wherein the communications device is a wireless communications device and the communications medium comprises a portion of an electromagnetic spectrum.

30. The communications device of claim 27, wherein the communications device is a wireline communications device and the communications medium is a cable comprising an electrical conductor.

31. A method for transmitting a signal at a desired power level, the method comprising:
generating at each power source of a plurality of power sources a respective contributive signal, each respective contributive signal being a fraction of the desired power level;
transforming an output impedance of each power source using a digitally-controlled transmission line (DCTL);
combining a respective contributive signal from each power source of the plurality of power sources to produce the signal at the desired power level; and
coupling the signal to a communications medium.

32. The method of claim 31, further comprising, after the combining, transforming an output impedance of a power combiner used to combine the respective contributive signals using a second DCTL.

33. The method of claim 31, wherein the generating comprises:
setting a state of a transistor based on a set of amplitude control bits and a clock signal; and
producing the respective contributive signal based on the state of the transistor.

34. The method of claim 33, wherein there are a plurality of transistors, and the set of digital control bits specifies a number of transistors in the plurality of transistors to turn on.

35. The method of claim 31, further comprising, time aligning the contributive signals from each power source of the plurality of power sources.

36. A wireless communications device comprising:
an integrated circuit configured to process data for transmission and process received signals from an antenna, wherein the integrated circuit includes an integrated power amplifier with a digitally controlled impedance transformation network; and
a front-end module coupled to the integrated circuit, the front-end module configured to allow a sharing of the antenna by circuitry in the integrated circuit.

37. The wireless communications device of claim 36, wherein the integrated circuit comprises:
a receiver coupled to the antenna, the receiver configured to receive signals detected by the antenna;
a transmitter coupled to a data source and to the communications medium, the transmitter configured to process data provided by a data source for transmission, producing a transmission signal, the transmitter comprising a power amplifier (PA), the PA configured to generate a plurality of fractional power transmission signals using a plurality of amplifiers, to controllably match an output impedance of each amplifier to a second impedance, and to combine an output of each amplifier together to produce the output transmission signal at a desired power level; and
a baseband processor coupled to the transmitter and to the receiver, the baseband processor configured to process signals received by the receiver and to be transmitted by the transmitter.

38. The wireless communications device of claim 37, wherein the PA comprises:
a plurality of micro-power amplifier (uPA) circuits;
a plurality of digitally-controlled transmission lines (DCTL), each DCTL coupled to an output of an uPA circuit in the plurality of uPA circuits, the DCTL configured to transform impedances from an output impedance of a respective uPA circuit to the second impedance; and
a power combiner circuit coupled to an output of each DCTL in the plurality of DCTL, the power combiner configured to combine outputs of each DCTL into an output of the PA.
